(19) United States
(12) Patent Application Publication
(10) Pub. No.: US 2018/0207047 A1
(43) Pub. Date: Jul. 26, 2018

(54) UPPER LIMB REHABILITATION TRAINING MACHINE

(71) Applicant: SHANGHAI FOURIER INTELLIGENCE CO., LTD., Shanghai (CN)

(72) Inventor: Zhenhua XU, Shanghai (CN)

(73) Assignee: SHANGHAI FOURIER INTELLIGENCE CO., LTD., Shanghai (CN)

(21) Appl. No.: 15/744,866

(22) PCT Filed: Jun. 30, 2017
(86) PCT No.: PCT/CN2017/091019

§ 371 Date: Jan. 15, 2018

(30) Foreign Application Priority Data
Jun. 30, 2016 (CN) 201610511087.8
Jun. 30, 2016 (CN) 201620684696.9

(51) Int. Cl. A61H 1/02; A63B 23/035; A63B 23/12

(52) U.S. Cl. CPC A61H 1/0274; A63B 23/03508; A63B 23/12; A61H 2201/1261; A63B 2220/833; A61H 2201/1664; A61H 2201/5015; A61H 2205/06; A63B 2220/51; A61H 2201/1635

(57) ABSTRACT

An upper limb rehabilitation training machine includes a hand support for supporting an upper limb and a movable plate. The hand support is arranged on the movable plate, and the hand support is slidable on the movable plate. When the upper limb rehabilitation training machine is used, an upper limb moves on the movable plate by the driving of the hand support, and meanwhile a user rotates correspondingly with the upper limb during the operation. An exercise path may be realized by presetting a path, or by an active rotation of the user, the exercise mode and training action are various, thus increasing the user's interest in using the machine and solving the problem that the upper limb rehabilitation training machine is inflexible and has a single exercise mode in use.

The present application claims the priorities to Chinese Patent Applications No. 201610511087.8 and No. 201620684696.9 titled “UPPER LIMB REHABILITATION TRAINING MACHINE”, filed with the Chinese State Intellectual Property Office on Jun. 30, 2016, the entire disclosures of which applications are incorporated herein by reference.

### FIELD

The present application relates to the technical field of medical instruments, and more specifically to an upper limb rehabilitation training machine.

### BACKGROUND

With the continuous development of the medical technology, rehabilitation therapy has become a new therapeutic discipline that promotes physical and mental function rehabilitation of patients and the disabled, and is also a new technical specialty. Its purpose is to enable people to restore daily production, study, work, labor and the ability of social life as much as possible, so as to integrate into society and improve the quality of life.

Patients having an upper limb losing motion capacity and having muscle atrophy due to cerebrovascular disease and cerebral trauma often do passive exercises with the help of external forces for rehabilitation training, which helps the patients to restore the upper limb strength.

However, the conventional rehabilitation training assistive devices are relatively clumsy, inflexible, and have a single exercise mode, fewer training motion types, a narrower motion range, and a boring operation, which cannot enhance user's interests in using the device, and increases the usage difficulty for user.

In addition, the upper limb rehabilitation training machines also have a problem of a complex structure and inability to directly work with human bodies.

In conclusion, a technical issue urgently to be addressed at present by those skilled in the art is to effectively solve the problems that the upper limb rehabilitation training machines are inflexible, and have a single exercise mode and fewer training motion types in use.

### SUMMARY

In view of this, an object of the present application is to provide an upper limb rehabilitation training machine, to solve the problems that the upper limb rehabilitation training machines are inflexible, and have a single exercise mode and fewer training motion types in use.

In order to obtain the object, a technical solution is provided according to the present application:

an upper limb rehabilitation training machine, including a hand support for supporting the upper limb and a movable plate, the hand support is arranged on the movable plate, and the hand support is slidable on the movable plate.

Preferably, the movable plate is provided with a first guide rail and a movable frame, the movable frame is located on the first guide rail and is slidable along the first guide rail. The movable frame is provided with a second guide rail, and the hand support is located on the movable frame and is slidable along the second guide rail.

Preferably, the first guide rail and the second guide rail are vertically arranged.

Preferably, a cross section of the movable plate is rectangular.

Preferably, the upper limb rehabilitation training machine further includes a base, and the movable plate and the base are connected by a retractable upright post.

Preferably, the movable plate and the movable frame are provided with a motor which drives the movable frame to slide along the first guide rail and a motor which drives the hand support to slide along the second guide rail, respectively.

Preferably, the movable plate is provided with a sensor for acquiring data.

Preferably, the movable plate is provided with a computer interface for connecting with a computer.

Preferably, the movable plate is provided with a power switch.

The upper limb rehabilitation training machine according to the present application includes a hand support for supporting an upper limb and a movable plate. The hand support is arranged on the movable plate, and is slidable on the movable plate. When the upper limb rehabilitation training machine is used, an upper limb moves on the movable plate by the driving of the hand support, and meanwhile, a user rotates correspondingly with the upper limb during the operation. An exercise path may be realized by presetting the path, or by active rotation of the user, the exercise mode and training action are various, thus increasing the user's interest in using the device and solve the problem that the upper limb rehabilitation training machine is not flexible in use and has a single exercise mode. Obviously, by arranging the hand support on the movable plate, and the hand support sliding on the movable plate, the upper limb rehabilitation training machine thus solves the problem that the upper rehabilitation training machines have a single exercise mode.

### BRIEF DESCRIPTION OF THE DRAWINGS

For more clearly illustrating embodiments of the present application or the technical solutions in the conventional technology, drawings referred to describe the embodiments or the conventional technology will be briefly described hereinafter. Apparently, the drawings in the following description are only some examples of the present application, and for the person skilled in the art, other drawings may be obtained based on these drawings without any creative efforts.

FIG. 1 is a front schematic view showing a structure of an upper rehabilitation training machine according to an embodiment of the present application.

FIG. 2 is a bottom schematic view showing the structure in FIG. 1.

### NUMERALS IN THE FIGURES

1 hand support,
2 movable frame,
3 movable plate,
4 upright post,
5 base,
6 computer interface,
7 power switch.

### DETAILED DESCRIPTION

An upper limb rehabilitation training machine is provided according to embodiments of the present application to solve the problems that the upper limb rehabilitation training machines are inflexible, have a single exercise mode and fewer training motion types in use.

The technical solution according to the embodiments of the present application will be described clearly and completely as follows in conjunction with the accompany drawings in the embodiments of the present application. It is obvious that the described embodiments are only a part of the embodiments according to the present application. All the other embodiments obtained by those skilled in the art based on the embodiments in the present application without any creative work belong to the scope of the present application.

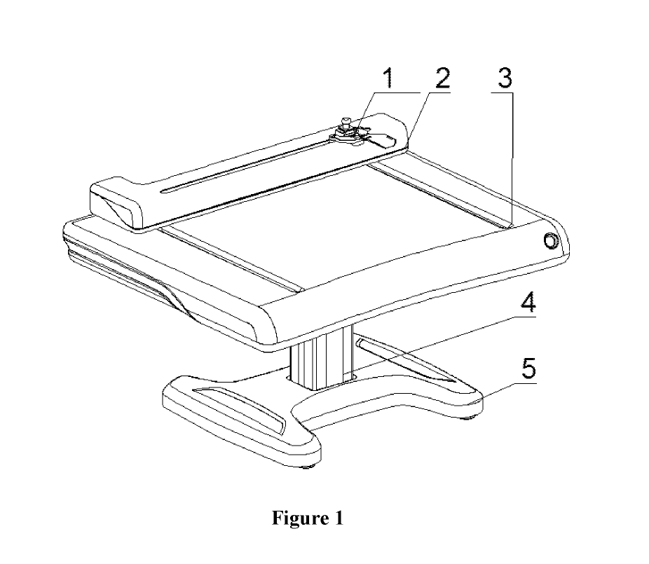

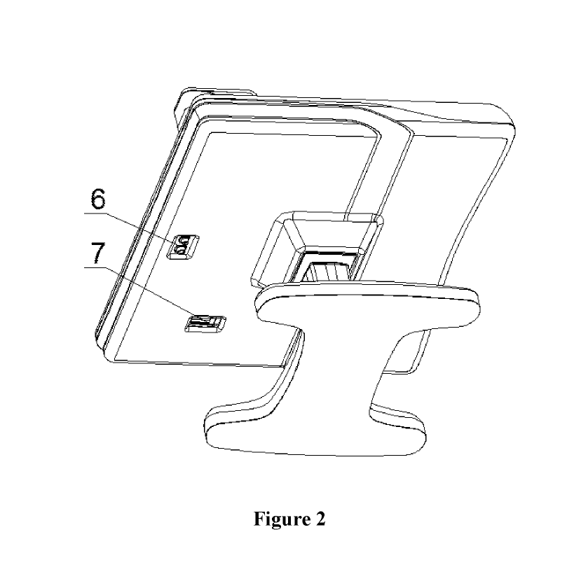

Referring to FIG. 1 and FIG. 2, FIG. 1 is a front schematic view showing a structure of an upper rehabilitation training machine according to an embodiment of the present application; and FIG. 2 is a bottom schematic view showing the structure in FIG. 1.

In a specific implementation, an upper limb rehabilitation training machine includes a hand support 1 for supporting the upper limb and a movable plate 3, the hand support 1 is arranged on the movable plate 3, and is slidable on the movable plate 3. When the upper limb rehabilitation training machine according to the present application is used, the hand support 1 drives an upper limb to move on the movable plate 3, and meanwhile, a user rotates correspondingly with the upper limb during the operation. Generally, an exercise path may be realized by presetting the path, or by active rotation of the user, thus the exercise mode and training action are various. Obviously, by arranging the hand support 1 on the movable plate 3, and the hand support 1 slidable on the movable plate 3, the upper limb rehabilitation training machine according to the present application completes the training process of the user, and solves the problem that the upper rehabilitation training machines have a single exercise mode. A specific form of the hand support is not limited herein, as long as the same technical object can be achieved.

The hand support 1 and a hand-held handle are designed according with ergonomics, generally, an outside of the hand support 1 is coated with a soft material, which makes the device operation more convenient and comfortable during the rehabilitation training of the user, and a smooth and clean surface is convenient for cleaning. In other embodiments, hand supports 1 of other types may also be chosen, and the specific form of the hand support is not specifically limited, which all falls within the protection scope of the present application.

Specifically, the movable plate 3 is provided with a first guide rail and a movable frame 2, and the movable frame 2 is located on the first guide rail and is slidable along the first guide rail. The movable frame 2 is provided with a second guide rail, and the hand support 1 is located on the movable frame 2 and is slidable along the second guide rail. The movable plate 3 is provided with the first guide rail, a sliding block may be arranged on the movable frame 2 to cooperate with the first guide rail, or other device may be arranged on the movable frame 2 to achieve the sliding fit. For a smooth sliding of the movable frame 2, generally there may be two first guide rails cooperating with each other. The first guide rail may be arranged along a circumference of the movable plate 3 or may be provided with a specific path. Specifically, the first guide rail may be set according to actual working needs. The movable frame 2 is provided with the second guide rail, and the hand support 1 is arranged on the movable frame 2 and is slidable along the second guide rail. Generally, the movable plate 3 is provided with a drive controlling panel corresponding to a motor, so as to provide the required power in real time. As described above, the specific implementation form is not limited, as long as the same technical effects can be achieved. In other embodiments, the hand support 1 may also be directly arranged on the movable plate 3 for corresponding setting, but due to the actual production situation, other devices are also required to be arranged to achieve the sliding when the guide rail is arranged, thus the structure is complex, and specifically, the arrangement may be carried out according to the actual production needs.

Further, the first guide rail and the second guide rail are vertically arranged. For better stretching the upper limb, the first guide rail and the second guide rail are vertically arranged. This arrangement has a simple structure, and is convenient for installation and repair. In other embodiments, other forms of arrangement may also be chosen.

Preferably, the connections between the hand support 1, the movable frame 2 and the movable plate 3 are of a hidden design, which facilitates the usage without affecting the appearance.

Furthermore, a cross section of the movable plate 3 is rectangular. In order to facilitate the arrangement and mounting, the movable plate 3 is a rectangular plate, thus the first guide rails can be arranged oppositely along two sides of the movable plate 3, and generally are arranged in parallel, which is more convenient for the installation and arrangement of the first guide rails, and the structure is simple. Of course, in other embodiments, the first guide rail may be set as a circular rail or rail of other forms, and the embodiments herein are only preferred embodiments.

Specifically, the upper limb rehabilitation training machine further includes a base 5, the movable plate 3 and the base 5 are connected by a retractable upright post 4. In order to meet the needs of different users, the movable plate 3 and the base 5 are connected by the upright post 4, the upright post 4 is retractable, and the movable plate 3 can be moved up and down freely by a manipulator. The user can adjust a height of the movable plate 3 according to his or her own height and the comfort degree of use, which has a wide range of applicability. As a support, the base 5 is preferably embodied as a base 5 with a large area, so that the overall stability is good and a movement space for leg is larger, thus the user can use the training machine for training comfortably. In other embodiments, an unretractable upright post 4 may also be arranged to connect the movable plate 3 and the base 5, which all falls within the protection scope of the present application.

Based on the above embodiments, the movable plate 3 and the movable frame 2 are provided with a motor which can drive the movable frame 2 to slide along the first guide rail and a motor which can drive the hand support 1 to slide along the second guide rail, respectively. By arranging the motor on the movable plate 3 and driving the movable frame 2 to slide along the first guide rail through the motor, the movable frame 2 can move flexibly on the first rail. The movable frame 2 is provided with the second guide rail, and the hand support 1 is arranged on the movable frame 2 and driven by the motor to slide along the second guide rail. In other embodiments, the motor may also be replaced by other power devices, and the embodiments herein are only preferred embodiments. Power is supplied by the motor, and various exercise modes can be provided such as power or resistance simulation, virtual mass simulation, traction simulation and the like, so as to provide better rehabilitation trainings for the user having hemiplegic upper limbs. The motor can be set to provide a certain assistance or resistance according to the user's needs, when the assistance is provided, the user can take an easier training under the drive of the motor; or the user him or herself drives the hand support 1 for exercise, and the certain assistance provided by the motor makes the training easier. When the motor provides the resistance, the resistance is provided by adding loads or other forms, the training intensity of the user is increased. Specifically, the resistance and assistance can be set according to the actual situations.

Specifically, the movable plate 3 is provided with a sensor for acquiring data. In order to better observe the training situation and physical index of the user, the movable plate 3 is provided with the sensor to simulate and acquire force feedback data, so as to record the data in the user rehabilitation training process in real time.

Further, the movable plate 3 is provided with a computer interface 6 for connecting with a computer. The computer interface 6 is generally arranged at a bottom of the movable plate 3, the training machine can record the data in the user rehabilitation training process in real time after being connected to an upper computer through a real time bus, and controls the overall exercise platform in real time according to the feedback data, thus providing visualized rehabilitation reports for the user.

Furthermore, the movable plate 3 is provided with a power switch 7. The power switch 7 is generally arranged at the bottom of the movable plate 3 to control the on-off of the whole training machine.

In a specific embodiment, the hand support 1 and the guide rail in the movable frame 2 are fixed by a connecting piece, and a motor in the movable plate 3 supplies the power for the hand support 1 to flexibly move transversely on the movable frame 2. The movable frame 2 and the movable plate 3 are fixed on the parallel guide rails in the movable plate 3 by the connecting piece, and the motor in the movable plate 3 supplies the power for the movable frame 2 to flexibly move forward and backward on the movable plate 3. Moreover, the motors are controlled by the drive controlling panel, and can be set to provide a certain assistance or resistance according to the user's needs.

The upright post is connected to the movable plate 3, and can be raised and lowered freely by operating the panel, so as to adjust the height of the movable plate 3. The computer interface 6 is connected to an external computer, the real time data are acquired from the sensor inside the movable frame 2 and the movable plate 3, so as to generate rehabilitation reports for the user.

Compared with the simple manual-operated rehabilitation assistive devices, the upper limb rehabilitation training machine according to the present application has a more convenient and intelligent operation process, and the operation is no longer boring.

The above embodiments are described in a progressive manner. Each of the embodiments is mainly focused on describing its differences from other embodiments, and references may be made among these embodiments with respect to the same or similar portions among these embodiments.

Based on the above description of the disclosed embodiments, the person skilled in the art is capable of carrying out or using the present application. It is obvious for the person skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

1. An upper limb rehabilitation training machine, comprising a hand support for supporting an upper limb and a movable plate, wherein the hand support is arranged on the movable plate, and the hand support is slidable on the movable plate.

2. The upper limb rehabilitation training machine according to claim 1, wherein the movable plate is provided with a first guide rail and a movable frame, the movable frame is located on the first guide rail and is slidable along the first guide rail; the movable frame is provided with a second guide rail, and the hand support is located on the movable frame and is slidable along the second guide rail.

3. The upper limb rehabilitation training machine according to claim 2, wherein the first guide rail and the second guide rail are vertically arranged.

4. The upper limb rehabilitation training machine according to claim 3, wherein a cross section of the movable plate is rectangular.

5. The upper limb rehabilitation training machine according to claim 4, wherein the upper limb rehabilitation training machine further comprises a base, and the movable plate and the base are connected by a retractable upright post.

6. The upper limb rehabilitation training machine according to claim 2, wherein the movable plate and the movable frame are provided with a motor which drives the movable frame to slide along the first guide rail and a motor which drives the hand support to slide along the second guide rail, respectively.

7. The upper limb rehabilitation training machine according to claim 6, wherein the movable plate is provided with a sensor for acquiring data.

8. The upper limb rehabilitation training machine according to claim 7, wherein the movable plate is provided with a computer interface for connecting with a computer.

9. The upper limb rehabilitation training machine according to claim 8, wherein the movable plate is provided with a power switch.

10. The upper limb rehabilitation training machine according to claim 3, wherein the movable plate and the movable frame are provided with a motor which drives the movable frame to slide along the first guide rail and a motor which drives the hand support to slide along the second guide rail, respectively.

11. The upper limb rehabilitation training machine according to claim 4, wherein the movable plate and the movable frame are provided with a motor which drives the movable frame to slide along the first guide rail and a motor which drives the hand support to slide along the second guide rail, respectively.

12. The upper limb rehabilitation training machine according to claim 5, wherein the movable plate and the movable frame are provided with a motor which drives the movable frame to slide along the first guide rail and a motor which drives the hand support to slide along the second guide rail, respectively.
